(19) United States
(12) Patent Application Publication
(10) Pub. No.: US 2024/0193648 A1
(43) Pub. Date: Jun. 13, 2024

(54) INVOICE PAYMENT AUTHORIZATION PLATFORM

(71) Applicant: Target Brands, Inc., Minneapolis, MN (US)

(72) Inventors: Manoj Vyas, Minneapolis, MN (US); Jonathon Cooke-Akaiwa, Minneapolis, MN (US); Edison Figueroa, Saint Paul, MN (US)

(21) Appl. No.: 18/065,500

(22) Filed: Dec. 13, 2022

(51) Int. Cl. G06Q 30/04

(52) U.S. Cl. CPC G06Q 30/04

(57) ABSTRACT

Increasingly, retail enterprises compete for timely and cost-efficient shipping of their merchandise. Handling of shipping invoices in an automated, centralized fashion to analyze both movement and invoicing events reduces the need for intervention and accomplishes these goals. A system for invoice processing can include a rate API that generates a system rate check output, and a load API that generates a system event check output. Both the rate API and the load API checks can have tolerances or smart features to add flexibility or a level of confidence that the check has passed. These two outputs can be weighed and processed to generate a result, automatically resulting in invoice payment in a majority of scenarios to increase accuracy and timeliness and therefore attractiveness of the retail organization to shippers.

The present disclosure is directed to methods and systems for tracking loads of items within a supply chain and managing corresponding invoices.

### BACKGROUND

In the context of supply chain management, timely and accurate processing of information related to shipments, cargo details, and invoicing is critical. With increasingly complex supply chains, manual management or approval of individual invoices and other shipment details becomes cumbersome and slow and is generally an inefficient use of resources.

Various software solutions exist that partially address the need to rapidly and accurately review and approve invoices and shipment details and provide freight invoice audit capability. Generally speaking, complex supply chain systems are managed using multiple software components that are operated separately from one another. Commercially available software systems are individually available to manage aspects of supply chain shipment management, invoice payment, and auditing. The outputs of these separate systems may then be required to be integrated at yet another in-house software tool or may need to be manually compared between systems to ensure that a particular shipment has been delivered and invoiced correctly.

To solve the complexity of shipping communications and invoicing, a standard system of communication forms is used in the industry. One of the predominant systems for such communications is the Electronic Data Interchange (EDI) standard. Various EDI forms, identified by number, exist that are used to communicate typical types of events, updates, and invoices between carriers, customers, and vendors. Some or all of the software must be capable of interfacing with a variety of Standard Carrier Alpha Code (SCAC) carriers and be capable of processing information using industry standards such as the EDI 214 transactions or EDI 210 invoices to identify status and contents of shipments. Other systems may be used that are not based on the EDI framework, which will have their own unique requirements and formats.

To date, each tool, carrier, and task may be managed by a different piece of software, and a retail enterprise that manages the supply chain must compile and compare each of these disparate data sources and reports before an invoice can be approved. This process can be cumbersome, time-consuming, and expensive, even when performed by software.

Furthermore, any data mismatch or an unexpected result can require manual deconstruction and analysis. Such mismatches or unexpected results can result not only from invoices with errors therein, but also from expected and routine occurrences such as receiving out-of-order reports from various carriers along a path from a vendor to a retail enterprise (or between the facilities of a retail enterprise).

A 30-day payment is standard in the transportation industry. However, depending on the carrier, the supply chain, and the software solutions that are implemented, only some of the invoices that are received either electronically or manually are successfully processed within this time frame. The remaining portion of the invoices, which can be as high as about 30-40% for some types of shipment, carrier, or supply chain operator, must be handled by a human to address various discrepancies between what existing systems expect to see before an invoice can be paid. Desirably, this human intervention should occur within the 30-day window for payment has elapsed. As shipping timelines generally become shorter, this 30-day window may not remain standard. For some shippers, retail enterprises, and types of goods, other windows (such as a 10-day window) may be required. As such timelines shorten, processing invoices within the window only becomes more important and more challenging.

In existing monolithic EDI 210 processing software, invoices may only be paid automatically (i.e., without human intervention) if a specific sequence of events is observed by the software. This sequence of events can include a particular message indicating completion of a carrier route is received and including acknowledgement of receipt. However, just because such messages are not yet received often does not mean that the event has not happened—it merely means that the event has not yet been registered or communicated. Sometimes EDI 214 transactions (updates of load status) are not entered into the enterprise system for various reasons, or at least not entered in a timely manner. While an EDI 214 may be required for ultimate payment of an invoice received via an EDI 210 transaction, it is not required to be a prerequisite to start the overall process. Still further, additional issues exist with respect to how tariffs are handled. Contracts are electronically transcribed into existing software, and there is not an adequate way to handle more than two stops on a move by a carrier in some software systems.

For these reasons, supply chain and logistics systems are not currently suited for rapid processing of invoices. As more processing of EDI documents is done in the realm of computer networks, processing is expected to be done more rapidly than was possible previously. More rapid processing of such invoices is important not only for haulers but also for the shipper. Slower or less reliable payments can affect the amount of time it takes for an invoice to a shipper or retail enterprise to be processed, creating cash flow issues that affect a shipper's freight attractiveness and cause haulers to prefer other freight. Elevated freight payment backlogs also drive a larger accrual, negatively impacting the timeliness and level of precision of freight expense allocation to merchant financials. This can have meaningful impact as merchants make profitability decisions without line of sight to total freight expense on their financials.

It would be desirable if a software tool could improve flexibility of rules that are applied for payment authorization of carriers in a supply chain network and improve automation of payments to carriers with reduced need for human intervention that can delay payments beyond industry standards.

### SUMMARY

According to a first embodiment, an invoice management platform includes at least one computing system of a retail enterprise. The at least one computing system includes a processor and a memory storing instructions which, when executed, cause the at least one computing system to receive, via a rate API, a first computer-generated invoice and a plurality of computer-generated transactions related to shipping charges and perform a rate verification process that generates a system rate check output. The at least one computing system is also configured to receive, via a load API, a plurality of computer-generated transactions related to inventory movements and perform a movement verification process that generates a system event check output independently of the system rate check output. The at least one computing system is also configured to receive, at an automated invoice processing API, the system rate check output and the system event check output. The at least one computing system can then generate, at the automated invoice processing API, a result corresponding to at least one of automated payment of the first computer-generated invoice or manual review of the first computer-generated invoice based on an indication that the system rate check output and the system event check output are within a set of models and rules stored in an audit database.

The plurality of computer-generated transactions related to inventory movements and the plurality of computer-generated transactions related to inventory management may be disjointed data sources. The rate API may be coupled to a tariffs API and a distance API. The load API can receive an EDI 214 form and can be coupled to systems for tracking loads and assigning them to carriers in response to bids. The system rate check output may be Boolean. The system rate check output may be a probability. The system event check output is Boolean. The system event check output may be a probability. The result may be a probability indicative of a level of risk for payment of the invoice. The system rate check output may be a probability, as may the system event check output, and the automated invoice processing API comprises a machine learning module configured to determine the probability indicative of the level of risk based on a set of training data. The rate API may be configured to receive a second computer-generated invoice corresponding to auxiliary shipping charges, and the rate API may be configured to automatically link the first and second computer-generated invoices. The system may also include a payments API configured to pay the first invoice upon receipt of a positive result from the automated invoice processing API.

According to a second embodiment, a method for streamlined processing computer-generated invoices in a retail supply chain is disclosed. The method includes receiving a first computer-generated invoice and a plurality of computer-generated transactions related to shipping charges at a rate API of an invoice management software platform. The method includes accessing a set of models and rules stored in an audit database, and performing a system rate check at the rate API of the plurality of computer-generated transactions related to shipping charges against the models and rules stored in the audit database to generate a system rate check output. The method includes receiving a plurality of computer-generated transactions related to inventory movements at a load API of the invoice management software platform, and performing a system event check at the load API to generate a system event check output of the plurality of computer-generated transactions related to inventory movements against the models and rules stored in the audit database The method includes sending the system rate check and the system event check output to an automated invoice processing API, and generating a result at the automated invoice processing API, the result corresponding to at least one of automated payment of the first computer-generated invoice or manual review of the first computer-generated invoice based on an indication that the system rate check output and the system event check output are within the set of models and rules stored in the audit database.

The plurality of computer-generated transactions related to inventory movements and the plurality of computer-generated transactions related to inventory management may be from disjointed data sources. The system rate check output may be Boolean, as may the system event check output. In other embodiments, the result may be a probability and may be indicative of a level of risk. The system rate check output may be a probability, and the system event check output may be a probability, and the automated invoice processing API can include a machine learning module configured to determine the probability indicative of the level of risk based on a set of training data. The rate API can be configured to receive a second computer-generated invoice corresponding to auxiliary shipping charges, and the rate API can be configured to automatically link the first and second computer-generated invoices.

According to a third embodiment, an automated invoice payment API of a retail enterprise includes at least one computing system including a processor and a memory storing instructions which, when executed, cause the at least one computing system to send and receive messages between a plurality of shippers and the retail enterprise. The automated invoice payment API includes an API core configured to receive a first computer-generated invoice, a plurality of computer-generated transactions related to shipping charges, and a plurality of computer-generated transactions related to inventory movements. The automated invoice payment API can include a machine learning module configured to determine the probability indicative of the level of risk based on a set of training data, a system rate check output from a rate API, and a system event check output from a load API.

### BRIEF DESCRIPTION OF THE DRAWINGS

The same number represents the same element or same type of element in all drawings.

FIG. 1 illustrates a system for inventory management for a retail enterprise;

FIG. 2 is a swim-lane chart of communications for first-mile communications in the system of FIG. 1;

FIG. 3A is a simplified software architecture depicting data inputs and outputs routes according to an embodiment;

FIG. 3B is a flowchart for a method of simultaneously handling movement and rate verification to expedite invoice handling with according to an embodiment;

FIG. 4 illustrates a system for invoice payment authorization according to an embodiment;

FIGS. 5A and 5B are example displays of centralized information output by an invoice payment authorization system.

FIG. 6 is a block diagram of an example computing system with which aspects of the present disclosure may be implemented.

### DETAILED DESCRIPTION

Embodiments of the present disclosure are directed to timely and accurate processing of information related to shipments, cargo details, and invoicing. Software tools, networks, systems, and methods described herein improve flexibility of rules that are applied for payment authorization of carriers in a supply chain network and improve automation of payments to carriers. More particularly, the present disclosure describes a load tracking computing platform for tracking freight shipments within a supply chain and aggregating information from multiple supply chain management systems using one user interface, as well as automated review of the corresponding invoices.

Throughout this disclosure, reference is made to “conditions” and “controls.” These two terms refer to related but different concepts. An example of a control is a system configuration “to update load statuses based on events that occur within the system to facilitate complete and accurate invoice payment estimate.” A condition is that this activity must take place within this control, which may or may not be necessary to fully satisfy the control.

Numerous conditions must be true for an invoice in a supply chain management system to seamlessly flow through the audit and authorization process. Any predefined condition that is not met in the correct sequence of activities may result in manual invoice handling, which is generally undesirable for the reasons described above related to accuracy and invoice aging. In a typical system for handling load movement information and invoice information for a retail enterprise, the data can come from different sources, as well as at different times. Receipt of data that is disjointed in time can require intervention or further processing to handle to verify that a shipment was made properly, for example. Receipt of data that is disjointed in source can require reconstruction to ensure that rates and events occurred as directed in the original order. In either case, disjointed data sources (whether disjointed temporally, disjointed in source location, or both) can require manual interventions that add to time and cost in handling of an invoice. As a way of handing issues around carrier submissions, rules can be defined at a granular level (e.g., carrier, specific lane, etc.) that can be chained together to build up a holistic audit. Such audit rules are interconnected, and one rule may modify or inform other rules affecting the final output. For example, if the carrier is sending a certain charge code but the contract for hauling that freight uses a different charge code, a retail enterprise may choose to temporarily add a rule to substitute these instances of the latter charge code with the former at the desired level of granularity. Rules can be applied retroactively, to ensure that all charges on a given invoice are found on the corresponding negotiated contract. In embodiments, rules can be automatically added for non-estimable charges based on historical approvals or adjustments by users.

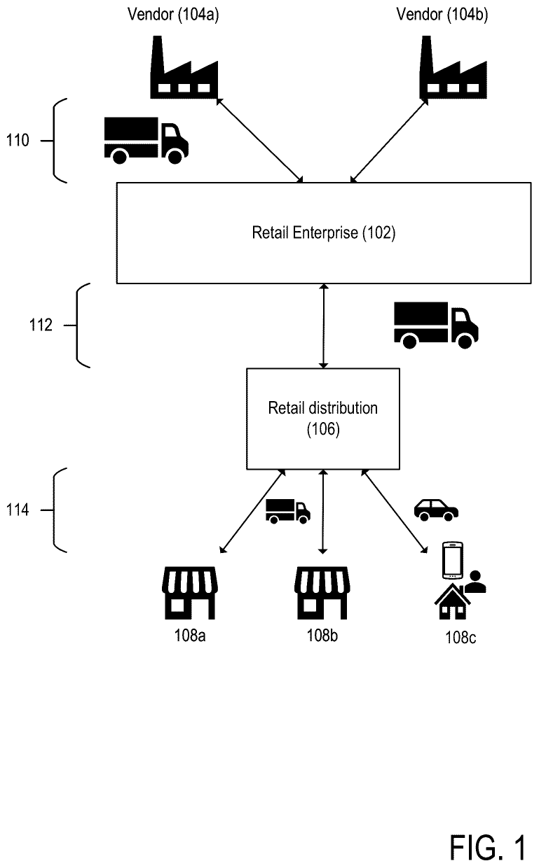

FIG. 1 illustrates a system 100 for inventory management for a retail enterprise 102. As shown in FIG. 1, the retail enterprise 102 interacts with a plurality of vendors (104a, 104b) to receive products. These products are sent via a retail distribution system 106 to customers (108a, 108b, 108c).

Product movements within system 100 can generally be thought of as being within one of three categories: a first-mile portion 110, a middle-mile portion 112, and a last-mile portion 114. Different shippers and haulers are used depending upon the portion (110, 112, 114) of the system 100 in which the product is moving. For some retail enterprises 102, first-mile portion 110 can be handled by contracted shippers using EDI transactions, while middle-mile portion 112 is handled by the retail enterprise 102 itself. Last-mile portion 114 can be handled in a variety of ways; for some retail enterprises 102, last-mile portion 114 can include customer pickup, a variety of individual shippers hired by customers, drop-shippers, or combinations thereof. In some embodiments, there may be overlap in the shippers used in each of the portions (110, 112, 114). For example, a retail enterprise 102 may choose to contract for the same shipper to handle middle-mile portion 112 shipments as those that handle first-mile portion 110 shipments.

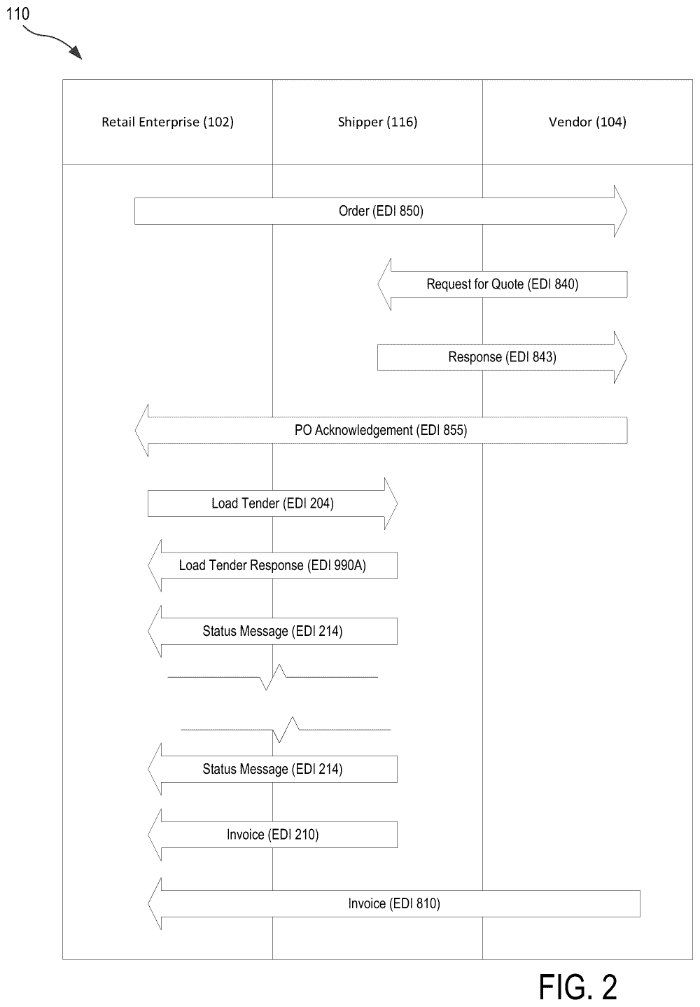

The arrows within first-mile portion 110, middle-mile portion 112, and last-mile portion 114 are bi-directional. These arrows indicate that there is both product and information flowing within system 100. As described in more detail below with respect to FIG. 2, for example, shipment from a vendor 104 to retail enterprise 102 can be complex and generate a large quantity of information flow between the shipper, the vendor 104, and the retail enterprise 102.

It should be recognized that the system 100 of FIG. 1 has been simplified for purposes of illustration, and that there may be a much larger number of vendors 104 and customers 108 than shown in FIG. 1. Additionally, FIG. 1 is simplified to show retail distribution 106 as a single location. While small retail enterprises 102 may have a single site for retail distribution 106, in most larger systems 100 there will be a network of distribution sites, warehouses, stores, and other facilities that make up retail distribution 106. In some embodiments, there may be shipments between these facilities, which can also be handled by contracted shippers using EDI invoices as described in more detail below.

Throughout system 100, and especially with respect to the shipments depicted by the arrows at first-mile portion 110 and middle-mile portion 112, there is a high level of pressure on both shippers and retail enterprises 102 to work efficiently. Shippers will attract more shipments by offering competitive rates and timely delivery, as well as offering specific types of service (e.g., liftgate service, long-haul deliveries, etc.) that are desired by the retail enterprise 102. In the scenario where retail enterprise 102 is choosing between multiple shippers willing to carry a product in first-mile portion 110 or middle-mile portion 112, the prices, timeliness, and services offered can affect which shipper is selected.

Often, however, shippers have their choice of freight to carry, or vary their rates according to a real or perceived ease of working with a particular retail enterprise 102. Therefore, retail enterprise 102 also benefits from making shipment instructions clear and accurate, and ensuring that payments are processed in a timely fashion.

Retail enterprise 102 includes an invoice payment authorization (IPA) platform 150. IPA platform 150 may coordinate events for reorder, shipping invoice handling, and shipper management, reducing the number of manual audits and removing process dependencies otherwise inherent in the audit process. As such, IPA platform 150 improves the overall operation of the system 100 by reordering and handling payments when certain computer-executable processes occur, and improves the efficiency of the platform itself relative to disjoint applications by reducing the latencies introduced by the need to wait for audit steps at various points through a process.

FIG. 2 shows a swim-lane chart of at least some of the communications that pass between a retail enterprise 102 and a vendor 104 as well as a shipper 116 within the context of a first-mile portion 110 such as the one shown and described with respect to system 100 of FIG. 1. While the process shown here is for a first-mile portion 110 shipment, a similar process could be used for middle-mile portion 112 or last-mile portion 114, depending upon the organization and shipping practices of retail organization 102.

As shown in FIG. 2, retail enterprise 102 first orders a product from a vendor 104. A standard EDI form, EDI 850, can be used to send such an order. The vendor 104 then sends a request for quote to the shipper 116 using a Request for Quote form, using the standard form number EDI 840. FIG. 2 shows a single response (using form EDI 843) but in many scenarios, multiple requests for quote (EDI 840) and responses (EDI 843) will be sent—for example, one to each of a number of shippers (e.g., 116).

When the response (EDI 843) is accepted, a PO Acknowledgement is sent from the vendor 104 to the retail enterprise 102 (using form EDI 855) and a load tender (form EDI 204) is sent from the retail enterprise 102 to the shipper 116. The load tender response (EDI 990A) is sent from the shipper 116 to the retail enterprise 102. At this stage, the load can be picked up and moved through the first-mile portion 110.

Throughout the pickup, movement, and delivery process, a number of status messages (using form EDI 214) may be delivered from the shipper 116 to the retail enterprise 102. This EDI 214 document can contain information about the status of the shipment, dates, or even routes associated with transit shipments. In some systems (e.g., 100), a new EDI 214 can be sent multiple times daily. In some systems, EDI 214 documents can be sent both to retail enterprise 102 and vendor 104. In others, there may be multiple shippers 116 handling different portions of the transit of an inventory movement, and therefore multiple sources of EDI 214 messages. The total number of EDI 214 documents in first-mile portion 100 is therefore variable. In some cases, EDI 214 documents may be delayed, such as when a shipment is in a location without network connectivity or due to some other delay, such that EDI 214 documents are received by the vendor 104 out of order. Additionally, forms under EDI 214 can be sent or received to and from various warehouses, transportation companies, and consignees along a route. Accordingly, the EDI 214 data can be disjointed both temporally and based on source of origin.

Some shippers 116 may not use the EDI system, or may not send a message through an EDI form in all instances. Therefore in addition to the EDI 214 status messages depicted in FIG. 2 as sent from shipper 116 to retail enterprise 102, there may be a mixture of EDI 214 and non-EDI status messages received during first-mile portion 110.

A final status message under EDI form 214 is sent as well as an invoice under EDI 210 when the delivery has been completed. These are delivered by the shipper 116 and the vendor 104 to the retail enterprise 102.

Handling of the EDI 210 and/or 810 requires making sense of all of the EDI and non-EDI forms received throughout the first-mile portion 110, ensuring that the shipment was completed as instructed (i.e., from the correct source to the right endpoint, within the promised timeframe). Other items may need to be checked such as that the product's environmental conditions were maintained, such as refrigeration or heating to avoid freezing. If the conditions in the initial order were not met, or the product was damaged or late, or the wrong product or the wrong quantity was delivered, then the final invoice may not be paid, or may need to be modified. These items are referred to as “movement verification” items to be checked.

Additionally, handling of the EDI 210 and 810 requires making sense of the fees charged. In theory, the request for quote (EDI 840) and the response (EDI 843) set out the rate for shipment of the goods. However, various modifications can legitimately affect the amount on the invoice (EDI 210 or EDI 810) such that it differs from the original estimate. For example, weather or road conditions can cause detours that change the total mileage of a delivery. Similarly, a shipper may need to use specialized equipment (such as a liftgate-enabled vehicle or a refrigerated truck) which may have been omitted on the original request for quote (EDI 840) or order (EDI 850). Some modifications to the originally-quoted rate are acceptable and can be paid without further processing after checking, referred to herein as “rate verification” items.

The manual handling of movement verification and rate verification checking is a time-consuming and cumbersome process. EDI forms have standardized matters to make manual processing easier for human operators to sort and handle. However, in recent years a larger portion of invoice processing in the retail environment is handled electronically. To date, rate handling and event handling checking has not taken advantage of tools that are available within the computer realm. Use of these tools, which can expedite and increase accuracy of invoice handling, make a retail enterprise (e.g., 102) more attractive to shippers (e.g., 116), therefore attracting more rapid and lower-cost quotes for shipments.

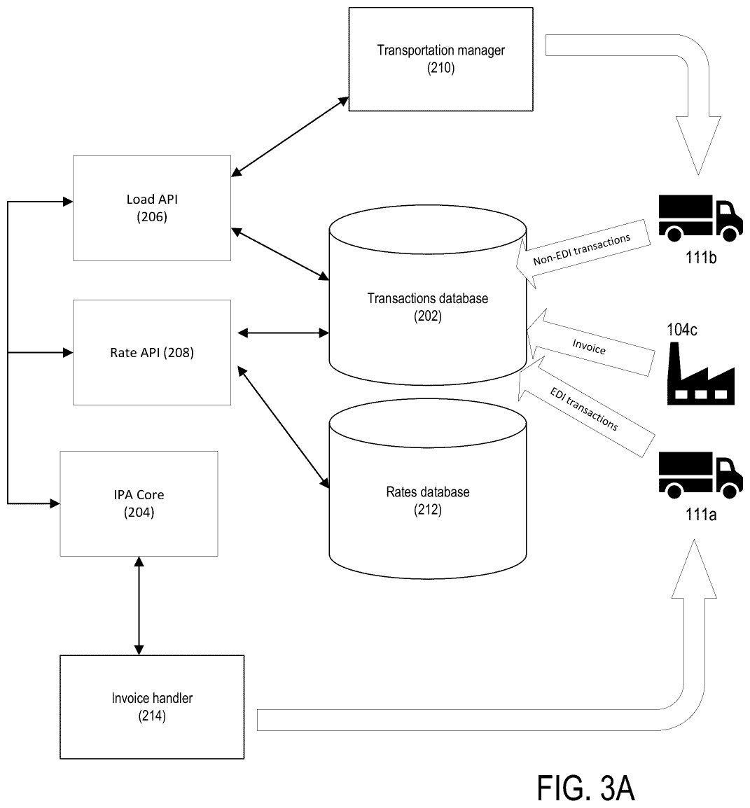

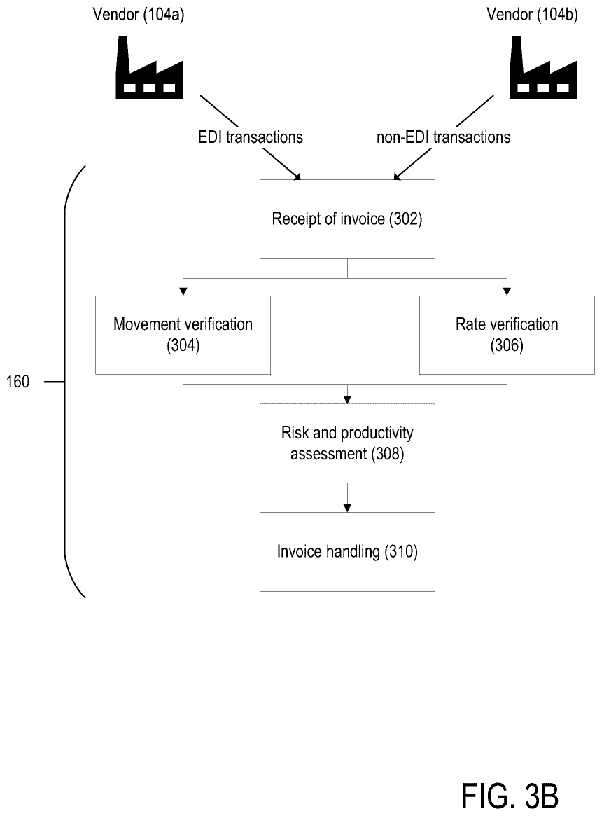

FIG. 3A shows a computing system, showing in a simplified form the receipt of EDI transactions (e.g., EDI form 214 information) and non-EDI transactions from shippers 111a and 111b, respectively. Invoices, such as those in EDI form 810 or EDI 210, are also received from a vendor 104c. In the simplified system shown in FIG. 3A, only a single vendor 104c and two shippers (111a and 111b) are depicted. However, for most retail enterprises, there are many more, such as several thousand or even tens of thousands of each type of entity.

These invoices and transactions, both EDI and non-EDI, are received at transactions database 202. These different types of transactions at transactions database 202 relating to inventory movement are delivered to Invoice Processing Application (IPA) Core 204 via load API 206. Similarly, transactions involving invoices are delivered to IPA core 204 via rate API 208.

Load API 206 not only transfers EDI and non-EDI inventory movement information to IPA Core 204, but also can receive and transfer instructions to be sent to the shipper to a transportation manager 210. Transportation manager 210 can then direct shippers (e.g., 111a, 111b).

As described above, rate API 208 not only receives invoice information, in either EDI or non-EDI format. This information can be received from supplier 104c. In alternative embodiments, invoices can be received from multiple suppliers or from shippers (e.g., 111a and 111b) or from a combination thereof. Rate API 208 can access rates database 212 for historical data on rates for other shipments, as well as rules or pricing models.

Transactions database 202 and rates database 212 are shown as unitary data stores in FIG. 3A. It should be understood that each of these may be made up of multiple smaller or distributed data stores.

IPA core 204 can perform process outputs from load API 206 and rate API 208 in accordance with the processes and the user interfaces below, such as with respect to FIG. 3B. In the event that IPA core 204 determines that a payment is authorized, IPA core 204 may send a message to invoice handler 214 which can then send payment to shippers (e.g., 111a and 111b) and vendors (e.g., 104c) of the corresponding shipment.

FIG. 3B shows one example of use of a flow path for the handling of EDI and non-EDI communications in accordance with aspects of the present disclosure, such as using the computer systems described above with respect to FIG. 3A. As shown in FIG. 3B, upon receipt of an invoice at 302, movement verification 304 and rate verification 306 can be completed in parallel.

Movement verification 304 as shown in FIG. 3B can be performed using load API 206 of FIG. 3A in one embodiment, to combine and send EDI and non-EDI transactions from shippers (111a and 111b in FIG. 3A) to an IPA core (214, FIG. 3A).

Similarly, rate verification 306 of FIG. 3B can be performed using rate API 208 of FIG. 3A in one embodiment, to combine EDI and non-EDI invoices from vendors (104c in FIG. 3A) or sometimes shippers (111a and 111b in FIG. 3A).

Conventionally, movement and rate verification steps might be done in series, as a human operator looked at movement verification steps first and then, assuming the movement verification check was approved, rate verification would be performed second. Additionally, each process is cumbersome, especially when both EDI and non-EDI information has been received, and when those data sources are disjointed in time (e.g., are received out of order from expected process). Conventionally, invoices are often processed only once all of the documents from shippers and vendors have been received, which then are processed using different tools (e.g., an EDI transaction processing tool, an EDI invoice processing tool, and a variety of other tools for non-EDI or miscellaneous documents and forms). Only when all these different analyses are conducted, in series, and combined manually can the conventional invoice approval process result in an approved invoice. This adds unwanted delay as an invoice assessment process cannot begin until all forms are received, and then multiple different sequential processes must be completed and manually combined. In contrast, the system shown in FIG. 3B can be executed in real time as information is received, continuously changing the output at movement verification 304 and rate verification 306 until both branches indicate that an invoice is ready to pay according to risk and productivity assessment 308.

Additionally, a computer-implemented solution to invoice handling can be based on a weighted or combined review of the movement verification 304 and rate verification 306 processes for every invoice. Only those invoices that have questionable or unusual events or invoices need further attention. In some anecdotal examples, a computer-implemented system can be configured to automatically process about 98% of invoices while maintaining business-appropriate audit processes, leaving only 2% for human review. This 2% takes far less time and resources to handle than even a partial audit of invoices handled in the sequential, serial fashion through disjoint software systems for movement and rate events.

In one example, an EDI 214 may indicate that a shipment required some further process, equipment, or detour, but was eventually delivered to the correct location. The passed rate check indicates that this deviation from expectations did not result in a cost change compared to the estimate (or that the change is acceptable under the terms of the shipment agreement). Under these circumstances, the invoice is automatically paid at invoice handling 310 because the movement verification 304 and rate verification 306 both show an acceptable outcome to risk and productivity assessment 308.

In another example, the event check may fail because an EDI 214 indicates that the wrong quantity or type of product was received, or that the product was received late or damaged. While the rate check still passes (i.e., the invoice matches expectations from the original estimate) this invoice should not be automatically paid, as it may be the case that adjustments or other human intervention is needed.

Returning to FIG. 3B, the output of movement verification 304 and rate verification 306 can be either Boolean (i.e., True/False corresponding to pass or fail, respectively) or a probability or closeness metric. In the scenario where the outputs are Boolean, a risk and productivity assessment 308 can receive these outputs and direct that the invoice handling module 310 pay the invoice when both are True.

In other embodiments, where movement verification 304 and rate verification 306 output a probability or other gauge, risk and productivity assessment 308 can use a more complex analysis. For example, movement verification 304 can determine that a mileage slightly different from the estimated mileage is acceptable, while a much different total mileage is unacceptable. This determination need not be absolute, but can instead be a value along a spectrum, for example, indicating a level of acceptability. In some instances, a mileage or other cost metric may be allowed to differ by a predetermined set amount, or a set percentage, relative to an expected or estimated value. Such a predetermined set amount may be preset by an authorized user at the retail enterprise, or set based on a model of historical ranges of acceptable deviations based on previously-authorized invoices.

Similarly, rate verification 306 can output an indication of some level of acceptability. In one example, a charge added for shipping lettuce may be approved. Upon receiving an invoice for the shipment that includes the surcharge for a refrigerated truck, rate verification 306 can determine the likelihood that this charge is valid (high). If the shipment were for golf balls instead, rate verification 306 may output a low likelihood of acceptability for the same charge.

The level of acceptability output by the movement verification 304 and rate verification 306 modules can be trained, either manually or via machine learning. In the lettuce and golf balls example above, for example, the rate verification 306 module can be pre-programmed with a list of items for which refrigeration charges are acceptable. Unlike a manual processing system, a computer-implemented system such as the one shown in FIGS. 3A and 3B can learn from approved and rejected invoices which items are likely to justify such charges. Furthermore, a machine learning module within rate verification 306 module can determine that, for example, all fresh produce is likely to incur such charges, while all sporting equipment is not.

Similarly, movement verification 304 module can incorporate data from various sources that would not normally be used by a human reviewer, such as real-time weather, traffic, and detour information. Movement verification 304 module can also ingest information into a machine learning module. For example, movement verification 304 module may determine not only that a lift gate charge is always added at a particular delivery location but determine a probability that a lift gate will be needed at other delivery locations belonging to the same type of delivery location.

Risk and productivity assessment 308 can input the assessments from movement verification 304 and rate verification 306 and generate a combined likelihood of the need for further human intervention before the invoice is processed. Invoice handling 310 can be automatic (in the scenario where the combined risk assessment at 308 is low) or manual (in the scenario where the combined risk assessment at 308 is high). In some instances, risk and productivity assessment 308 may prioritize which invoices have the highest risk of containing an error or deviation from approved costs, and human operators can then prioritize which invoices are considered manually and which are automatically paid. The assessments from movement verification 304 and rate verification 306 can include automated correction for carrier behavior, or configuration of checks for specific types or criteria of invoices. In embodiments, these rules may also be applied, relaxed, or modified temporarily as a way of resolving short-term issues either with the carrier or within our own system, such as when invoice processing times are approaching a preset acceptable amount.

Manually processed invoices can be fed back to the machine learning systems (if any) within the system 300, indicating whether the movement verification 304 or rate verification 306 modules accurately or inaccurately identified a risk. This feedback loop can improve the detection of aberrant invoices that are received subsequently. Additionally, shippers that send EDI 214s or other forms that routinely flag invoices as questionable can be identified, so that those shippers can be directed to standardize their forms and therefore speed processing of their invoices.

Due to these increases in efficiency, invoice handling 310 is significantly faster than manual processing. In one test, invoice handling could be increased from about 60 per hour to about 6000 per hour.

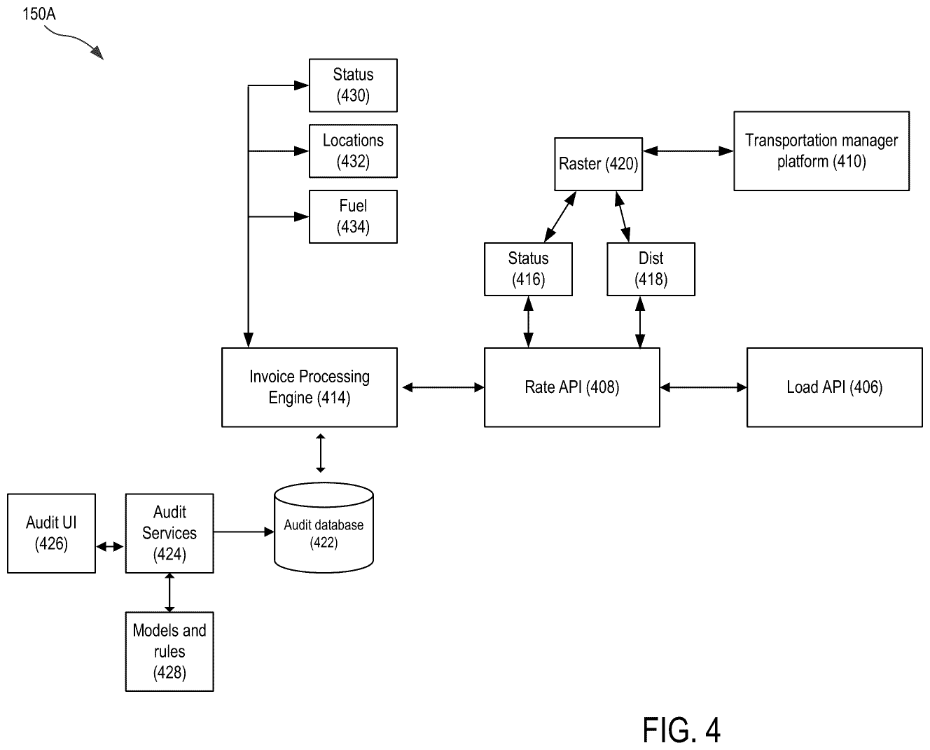

FIG. 4 shows a block diagram of an embodiment of an IPA platform 150A for invoice processing, according to one example of the IPA platform 150 shown and described above. In this example, an invoice in the form of an EDI 210 or EDI 810 form is received at rate API 408, which is similar to the rate API 208 described above. Additional, non-EDI invoices 303 can also be received at the rate API 408.

Rate API 408 can check the received invoices against load status at status module 416, or distance traveled at distance module 418. These checks can be combined at raster 420 and sent to transportation manager platform 410, which is similar to transportation manager 210 as previously described with respect to FIG. 3A. Transportation manager platform 410 can send instructions for product movements to shippers, including the various EDI communications described above with respect to FIG. 2, or in some cases non-EDI communications to shippers that use an alternative system. The transportation manager platform 410 can be a system that assigns specific loads to specific carriers based on auctions or other criteria. One example of such a system is described in applicant's application U.S. Ser. No. 16/696,577 (published as US 2021/0158275), the contents of which are incorporated herein in its entirety by reference.

Load API 406 also receives EDI and—in some cases—non-EDI transactions related to product movement. Load API 406 is similar to the load API 206 described above with respect to FIGS. 3A and 3B. Load API 406 and rate API 408 communicate with one another as indicated by the arrows in FIG. 4, as well as with invoice processing engine 414. Invoice processing engine is similar to invoice handler 214 of FIG. 3A, with some additional details shown in FIG. 4. Specifically, FIG. 4 shows audit database 422, which can include repositories of information, rules, algorithms, or patterns of previously approved and rejected invoices, acceptable or unacceptable rates and surcharges. Audit database 422 can be connected to an audit services module 424, through which such stored information in audit database 422 can be combined with the received invoices (via rate API 408 and invoice processing engine 414) to provide a display of any information that needs manual review at audit UI 426. Audit UI 426 can also be used in some circumstances to add rules, rates, or other information to audit database 422 via audit services 424.

Additionally or alternatively, rates and rules for invoice processing can be set at models and rule module 428. Models and rules can be set at a global level for the system, or at a carrier level, in some embodiments. Models and rules module 428 can be accessed manually, via audit UI 426 and via audit services 424. Alternatively, data regarding previous audits, approved invoices, and disapproved invoices stored at audit database 422 can be accessed via audit services module 424 such that models and rules module 428 can refine the models and rules stored therein. Such refining and improving can be done manually in some embodiments, whereas in others the models and rules modules 428 can iteratively improve automatically, using manual or machine-learning processes.

Invoice processing engine 414 can also access current information regarding load status 430, shipment locations 432, and fuel pricing 434. This information can be used in ascertaining whether information received at load API 406 and rate API 408 are acceptable. For example, if fuel prices change significantly (as identified at fuel pricing 434) a higher invoice received at rate API 408 may be accepted despite the fact that the total price exceeds previously-accepted invoices at audit database 422.

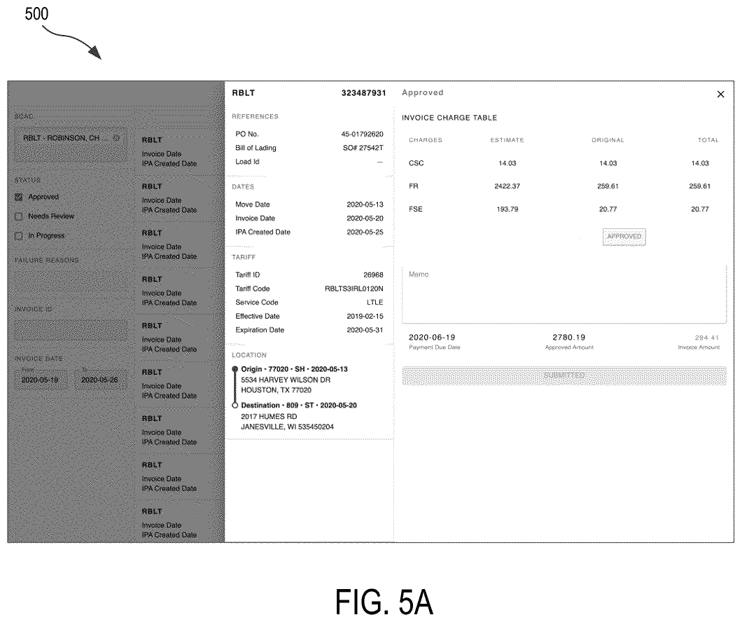

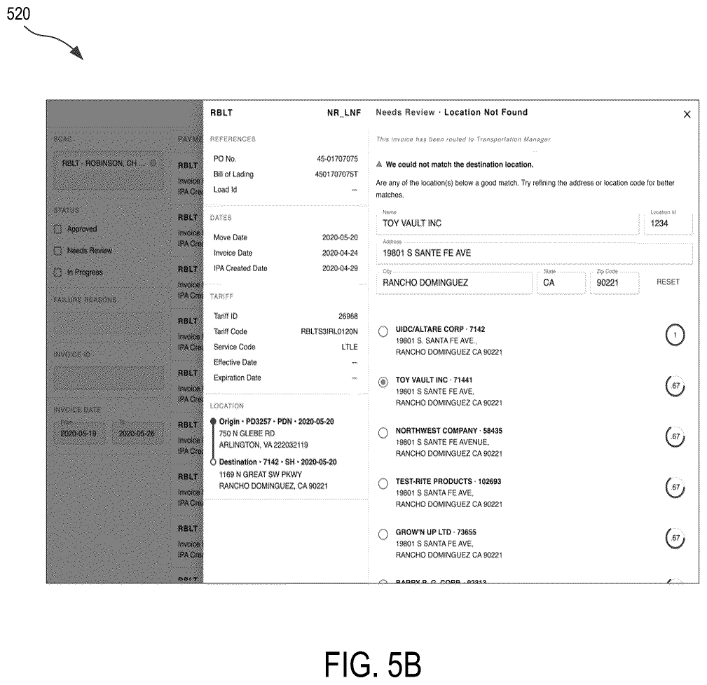

FIGS. 5A and 5B show example user interfaces 500, 520, respectively that depict automatically approved and rejected invoices, respectively.

As shown in FIG. 5A, user interface 500 depicts all of the relevant information including addresses, dates, codes, and invoice amounts are presented in a single page, along with an APPROVED indication. This APPROVED indication is an output created through the combination and—optionally—combination or other processing of data from several EDIs aggregated onto a single user interface. The aggregated data on the single user interface can be displayed in combination or conjunction with known information by the retail enterprise, and may either display the automated approval or rejected status or can have easy tools for accepting and rejecting (or modifying the automated outcome).

In contrast, FIG. 5B shows the user interface 520 in the instance where has been rejected due to an event check failure. The combination and processing of EDI data in the embodiment of FIG. 5B has attempted a matching process for the destination to either automatically determine that the data is accurate or, if not, to assist the user with manual review. As shown in the user interface depicted in FIG. 5B, the location of destination could not be identified. The display in FIG. 5B shows a number of potential options for recognized locations, and a level of probability that each is the intended location. These can be selected during manual review to finalize an invoice more rapidly than would otherwise be possible. Locations may be provided by including a reference ID to a location, or by providing an address to the location. If a carrier provides a location address, this may align with the address for that location entered within the retail enterprise's system. As a way of resolving this issue the address may be matched using a heuristic to choose the most accurate location from a list of possible choices.

By presenting all of this information in one combined set of user interfaces, the freight payment solution depicted in FIGS. 5A and 5B is a service-oriented architecture. The IPA application can facilitate the use of rate and load audit and tracking functions via a user interface (UI) with view and edit capabilities for overall invoice workflow management. These services can be called as needed dependent on what actions must take place to audit and authorize an invoice. The intelligence built around these actions improves user experience compared to how users interact with conventional solutions.

Payment process simplicity and flexibility is improved by decoupling freight audit and authorization. Payment processes can seamlessly be executed as new sourcing & routing strategies are deployed by operations teams of a retail organization using such a system. The retail organization using such a system will be perceived as a shipper of choice related to payment as the number of invoices paid within carrier payment terms improves with automatic and rapid processing. Within the retail organization, clear view and edit workflow management capabilities are enabled by a user interface customized for the unique needs of end-users.

Shippers may also upload manual invoices as shown in FIG. 4 to create digital records through the IPA UI to flow downstream rather than sending emails to various freight payment inboxes, improving current processes. Error codes for invoices that flow into the manual queue can be set that are specific and intuitive based on the particular reasons that the invoice was flagged for further review. When multiple valid tariffs are present, the centralized API can identify the correct tariff service based on the mode of the move. The centralized API can also identify original and balance due invoices which can be audited side-by-side. This functionality will catch instances where accessorials may be double-invoiced.

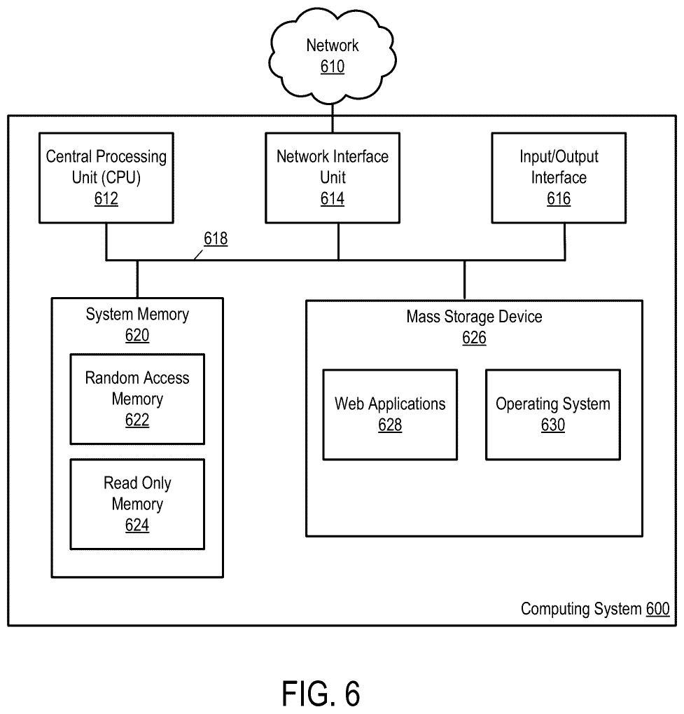

FIG. 6 is a block diagram of an example computing system with which aspects of the present disclosure may be implemented. In the embodiment shown, the computing system 600 includes at least one central processing unit (“CPU”) 612, a system memory 620, and a system bus 618 that couples the system memory 620 to the CPU 612. The system memory 620 includes a random access memory (“RAM”) 622 and a read-only memory (“ROM”) 624. A basic input/output system that contains the basic routines that help to transfer information between elements within the computing system 600, such as during startup, is stored in the ROM 624. The computing system 600 further includes a mass storage device 626. The mass storage device 626 is able to store software instructions and data.

The mass storage device 626 is connected to the CPU 612 through a mass storage controller (not shown) connected to the system bus 618. The mass storage device 626 and its associated computer-readable storage media provide non-volatile, non-transitory data storage for the computing system 600. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 612 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 600.

According to various embodiments of the invention, the computing system 600 may operate in a networked environment using logical connections to remote network devices through a network 610, such as a wireless network, the Internet, or another type of network. The computing system 600 may connect to the network 610 through a network interface unit 614 connected to the system bus 618. It should be appreciated that the network interface unit 614 may also be utilized to connect to other types of networks and remote computing systems. The computing system 600 also includes an input/output controller 616 for receiving and processing input from a number of other devices, including a touch user interface display screen, or another type of input device. Similarly, the input/output controller 616 may provide output to a touch user interface display screen or other type of output device.

As mentioned briefly above, the mass storage device 626 and the RAM 622 of the computing system 600 can store software instructions and data. The software instructions include an operating system 630 suitable for controlling the operation of the computing system 600. The mass storage device 626 and/or the RAM 622 also store software instructions 628, that when executed by the CPU 612, cause the computing system 600 to provide the functionality discussed in this document. For example, the mass storage device 626 and/or the RAM 622 can store software instructions that, when executed by the CPU 612, cause the computing system 600 to provide a library for state management within a front-end user interface component management framework.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of state storage structures, technologies disclosed herein are applicable to web technologies generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. An invoice management platform comprising:
at least one computing system of a retail enterprise, the at least one computing system including a processor and a memory storing instructions which, when executed, cause the at least one computing system to:
receive, via a rate API, a first computer-generated invoice and a plurality of computer-generated transactions related to shipping charges and perform a rate verification process that generates a system rate check output;
receive, via a load API, a plurality of computer-generated transactions related to inventory movements and perform a movement verification process that generates a system event check output independently of the system rate check output;
receive, at an automated invoice processing API, the system rate check output and the system event check output, and
generate, at the automated invoice processing API, a result corresponding to at least one of automated payment of the first computer-generated invoice or manual review of the first computer-generated invoice based on an indication that the system rate check output and the system event check output are within a set of models and rules stored in an audit database.

2. The invoice management platform of claim 1, wherein the plurality of computer-generated transactions related to inventory movements and the plurality of computer-generated transactions related to shipping charges include both EDI and non-EDI transactions.

3. The invoice management platform of claim 1, wherein the rate API is coupled to a tariffs API and a distance API.

4. The invoice management platform of claim 1, wherein the plurality of computer-generated transactions related to inventory movements and the plurality of computer-generated transactions related to shipping charges are received disjoint in time.

5. The invoice management platform of claim 1, wherein the system rate check output is Boolean.

6. The invoice management platform of claim 1, wherein the system rate check output is a probability.

7. The invoice management platform of claim 1, wherein the system event check output is Boolean.

8. The invoice management platform of claim 1, wherein the system event check output is a probability.

9. The invoice management platform of claim 1, wherein the result is a probability and is indicative of a level of risk.

10. The invoice management platform of claim 9, wherein:
the system rate check output is a probability;
the system event check output is a probability; and
the automated invoice processing API comprises a machine learning module configured to determine the probability indicative of the level of risk based on a set of training data.

11. The invoice management platform of claim 1, wherein the rate API is configured to receive a second computer-generated invoice corresponding to auxiliary shipping charges, and the rate API is configured to automatically link the first and second computer-generated invoices.

12. The invoice management platform of claim 1, further comprising a payments API configured to pay the first invoice upon receipt of a positive result from the automated invoice processing API.

13. A method for streamlined processing computer-generated invoices in a retail supply chain, the method comprising:
receiving a first computer-generated invoice and a plurality of computer-generated transactions related to shipping charges at a rate API of an invoice management software platform;
accessing a set of models and rules stored in an audit database; performing a system rate check at the rate API of the plurality of computer-generated transactions related to shipping charges against the models and rules stored in the audit database to generate a system rate check output;
receiving a plurality of computer-generated transactions related to inventory movements at a load API of the invoice management software platform;
performing a system event check at the load API to generate a system event check output of the plurality of computer-generated transactions related to inventory movements against the models and rules stored in the audit database;
sending the system rate check and the system event check output to an automated invoice processing API;
generating a result at the automated invoice processing API, the result corresponding to at least one of automated payment of the first computer-generated invoice or manual review of the first computer-generated invoice based on an indication that the system rate check output and the system event check output are within the set of models and rules stored in the audit database.

14. The method of claim 13, wherein the plurality of computer-generated transactions related to inventory movements and the plurality of computer-generated transactions related to inventory management are disjointed data sources.

15. The method of claim 13, wherein the system rate check output is Boolean.

16. The method of claim 13, wherein the system event check output is Boolean.

17. The method of claim 13, wherein the result is a probability and is indicative of a level of risk.

18. The method of claim 13, wherein:
the system rate check output is a probability;
the system event check output is a probability; and
the automated invoice processing API comprises a machine learning module configured to determine the probability indicative of the level of risk based on a set of training data

19. The method of claim 13, wherein the rate API is configured to receive a second computer-generated invoice corresponding to auxiliary shipping charges, and the rate API is configured to automatically link the first and second computer-generated invoices.

20. An automated invoice payment API of a retail enterprise, the automated invoice payment API comprising:
at least one computing system including a processor and a memory storing instructions which, when executed, cause the at least one computing system to send and receive messages between a plurality of shippers and the retail enterprise;
an API core configured to receive a first computer-generated invoice, a plurality of computer-generated transactions related to shipping charges, and a plurality of computer-generated transactions related to inventory movements; and
a machine learning module configured to determine the probability indicative of the level of risk based on a set of training data, a system rate check output from a rate API, and a system event check output from a load API.
